(19) United States
(12) Patent Application Publication
(10) Pub. No.: US 2020/0246777 A1
(43) Pub. Date: Aug. 6, 2020

(54) MONTMORILLONITE-BASED LIQUID CHROMATOGRAPHY COLUMN

(71) Applicant: KING SAUD UNIVERSITY, Riyadh (SA)

(72) Inventors: AHMAD IFSEISI AQEL, RIYADH (SA); AYMAN ABDELGHAFAR AHMED, RIYADH (SA); AHMED-YACINE BADJAH-HADJ-AHMED, RIYADH (SA); ZEID ABDULLAH ALOTHMAN, RIYADH (SA)

(21) Appl. No.: 16/267,348

(22) Filed: Feb. 4, 2019

(51) Int. Cl. B01J 20/282; B01J 20/16; B01J 20/28; B01J 20/281

(52) U.S. Cl. CPC B01J 20/282; B01J 20/16; B01J 20/28061; G01N 2030/027; B01J 20/28016; G01N 30/482; B01J 2220/54; B01J 20/28004

(57) ABSTRACT

The montmorillonite-based liquid chromatography column is a chromatography column, which may be steel, packed with unmodified montmorillonite for use in normal phase liquid chromatography, particularly high-performance liquid chromatography (HPLC). The column may be prepared by sieving montmorillonite to achieve a desired particle size range, preferably in the micrometer range, i.e., montmorillonite microparticles, and more preferably between 5-10 μm. The montmorillonite microparticles are suspended in a solvent, for example, ethanol, and packed into a column for use in HPLC. Before packing, the montmorillonite microparticles may be dried by, for example, heating for a period of time, e.g., by heating preferably at about 100° C. for at least 2 hours. The packing may be performed at a pressure of at least 5000 psi, and more preferably, between 5000-7000 psi. The column may be used for separation of simple polar compounds under relatively low pressure conditions.

### BACKGROUND

### 1. Field

The present application relates to liquid chromatography apparatus, and particularly to a montmorillonite-based liquid chromatography column, especially for high-performance liquid chromatography (HPLC).

### 2. Description of the Related Art

High-performance liquid chromatography (HPLC) is a powerful separation and analysis technique widely used to isolate and purify a wide range of chemicals, such as biological, pharmaceutical, environmental, food and petrochemical compounds. There is an everpresent and growing need to establish new HPLC methods, particularly methods that reduce analysis cost, time and waste while enhancing sensitivity and separation efficiency. In HPLC, separation of analyte mixtures takes place through a column, the separation efficiency of which relies mainly on the stationary phase materials contained therein.

Montmorillonite is a clay, specifically a subclass of smectites (2:1 clays). Montmorillonite consists of a central octahedral sheet of alumina surrounded by two tetrahedral sheets of silica. These silicate sheets have a plate particulate shape with an average thickness of about 10 Å. Bare montmorillonite is intrinsically hydrophilic. However, surface modification to increase hydrophobicity of the silicate layers is possible, making montmorillonite adaptable to a wide array of material applications.

Due to its considerable availability, low cost, good mechanical strength, excellent thermal stability, high solvent resistance, ease of functionalization and low toxicity, montmorillonite is commonly used, for example, as a sorbent for removing heavy metals and trace pollutants, a treatment for contact dermatitis, a component of drilling mud, an additive to hold soil water in drought-prone soils, a desiccant to remove moisture from air and gases, a component in foundry sand, an additive in catalytic processes, an annular seal or plug for water wells, a protective liner for landfills, a retention and drainage aid component, an anticaking agent in animal feed, an additive in cosmetics, a flocculant in ponds, an additive to minimize deposit formation in paper making, and many other applications. Many of the properties that make montmorillonite so useful in the above applications are commensurate with an effective stationary phase in a chromatography column.

Raw montmorillonite is not suitable as a stationary phase for reversed-phase liquid chromatography in the presence of water as a component of the mobile phase. Montmorillonite undergoes reversible expansion upon absorbing water, and would thereby be an unstable stationary phase material. Thus, a montmorillonite-based liquid chromatography column solving the aforementioned problems is desired.

### SUMMARY OF THE INVENTION

The montmorillonite-based liquid chromatography column is a chromatography column, which may be steel, packed with unmodified montmorillonite for use in normal phase liquid chromatography, particularly high-performance liquid chromatography (HPLC). The column may be prepared by sieving montmorillonite to achieve a desired particle size range, preferably in the micrometer range, i.e., montmorillonite microparticles, and more preferably between 5-10 μm. The montmorillonite microparticles are suspended in a solvent, for example, ethanol, and packed into a column for use in HPLC. Before packing, the montmorillonite microparticles may be dried by, for example, heating for a period of time, e.g., by heating preferably at about 100° C. for at least 2 hours. The packing may be performed at a pressure of at least 5000 psi, and more preferably, between 5000-7000 psi.

The montmorillonite microparticles prepared as described above provide an effective stationary phase for use under low pressure conditions, e.g., in separating simple polar compounds, including some phenols and drugs, via normal-phase liquid chromatography mode. Alternatively, the montmorillonite could be used for functionalization of, or incorporation into, organic porous polymers, such as polymethacrylates, polyacrylates or polystyrenes, resulting in a composite material that could be applied as stationary phase for separations in reversed-phase mode, as well as use in normal-phase mode.

These and other features of the present disclosure will become readily apparent upon further review of the following specification and drawings.

### BRIEF DESCRIPTION OF THE DRAWINGS

FIGS. 1A and 1B are scanning electron microscopy (SEM) micrographs of montmorillonite before sieving and after sieving, respectively.

FIG. 2 is the Fourier transform infrared (FTIR) spectrum of montmorillonite prepared for use as the stationary phase in an HPLC column.

FIG. 3 shows a plot of column back-pressure versus mobile phase flow rate in the range 0.1-1.0 mL/min of the montmorillonite-based liquid chromatography column described herein for various common solvents used in HPLC, including hexane, acetonitrile, methanol, ethanol and isopropanol.

FIG. 4A is a plot of back-pressure versus operation days for the montmorillonite-based liquid chromatography column described herein at a fixed flow rate of acetonitrile, 0.5 mL/min.

FIG. 4B is a plot of back-pressure versus temperature for the montmorillonite-based liquid chromatography column described herein at a flow rate of 0.5 mL/min acetonitrile eluent.

FIG. 5 is a separation chromatogram of phenolic compounds using the montmorillonite-based liquid chromatography column described herein, with peak identification by order of elution: (1) phenol, (2) resorcinol and (3) phloroglucinol.

FIG. 6 is a separation chromatogram of caffeine and ibuprofen extracted from Profinal-XP tablets using the montmorillonite-based liquid chromatography column described herein, with peak identification by order of elution: (1) caffeine and (2) ibuprofen.

FIG. 7 is a separation chromatogram of vitamin C and aspirin extracted from Aspirin-C tablets using the montmorillonite-based liquid chromatography column described herein, with peak identification by order of elution: (1) aspirin and (2) vitamin C.

FIG. 8 is a separation chromatogram of paracetamol and chlorzoxazone extracted from Relaxon capsules using the montmorillonite-based liquid chromatography column described herein, with peak identification by order of elution: (1) chlorzoxazone and (2) paracetamol.

Similar reference characters denote corresponding features consistently throughout the attached drawings.

### DETAILED DESCRIPTION OF THE PREFERRED EMBODIMENTS

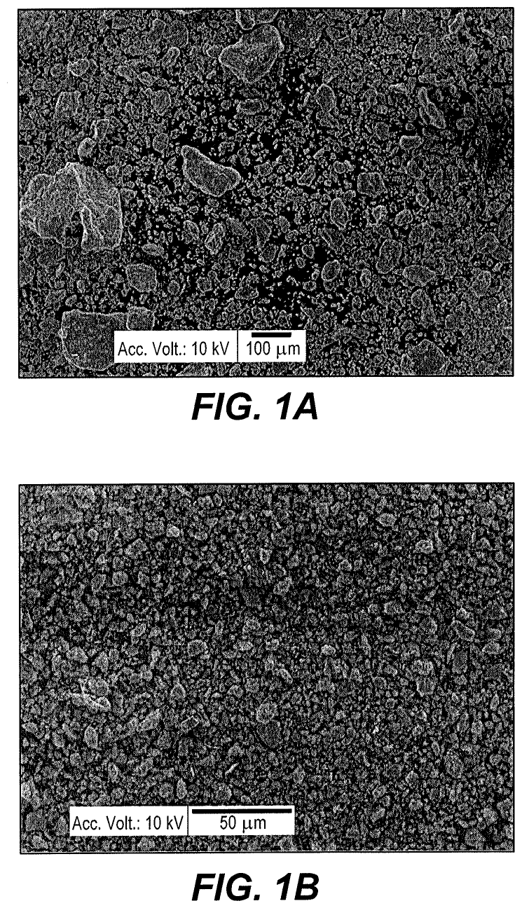

Raw montmorillonite is usually present in a wide range of particle diameters. In order to prepare an efficient HPLC column with suitable particle size, shape and distribution, montmorillonite is sieved before being packed into the columns. FIGS. 1A and 1B are scanning electron microscopy (SEM) micrographs of an exemplary sample of montmorillonite before sieving and after sieving, respectively, which resulted in obtaining a uniform distribution of particle sizes between 5-10 μm. The resulting montmorillonite microparticles were heated in an oven to remove any moisture from the silicate layer of the montmorillonite microparticles. In this example, the montmorillonite fine powder was heated at 100° C. for 2 hours.

In preparing the exemplary montmorillonite column, the specific surface area of the montmorillonite before and after sieving was obtained using liquid N₂ physisorption, analyzed according to the Langmuir and Brunauer-Emmett-Teller (BET) theory. Langmuir analysis of montmorillonite before and after sieving gave specific surface areas of 433.63 m²/g and 536.69 m²/g, respectively. BET analysis of the montmorillonite before and after sieving gave specific surface areas of 274.36 m²/g and 339.50 m²/g, respectively. These values confirm that the sieving process resulted in montmorillonite microparticles with significantly increased specific surface area, thereby providing more interaction sites and enhanced retention characteristics compared to raw montmorillonite.

To achieve and maintain a uniform stationary phase in the column, the sieved montmorillonite microparticles are dispersed in a solvent, such as ethanol. In an exemplary column preparation, 1.0 g of the sieved montmorillonite microparticles was dispersed by sonication in 10 mL ethanol for 10 min. The sieved montmorillonite microparticles were well suspended and stable in ethanol solvent. No deposition of montmorillonite microparticles was observed for at least 1 hour after dispersion. Other solvents, including methanol, isopropanol and cyclohexanol, could also used to obtain a homogenous montmorillonite microparticle suspension.

While maintaining a uniform and stable suspension, the montmorillonite microparticle suspension is poured, preferably immediately after mixing, into an empty stainless steel column. Preferably, the column has a height less than or equal to 10 cm, more preferably from 5-10 cm, and has an internal diameter preferably in the range from 2.1-4.6 mm. In the following exemplary applications, a steel column having approximate dimensions of 5 cm height×2.1 mm internal diameter was used. The suspension is packed under pressure, preferably above 5000 psi, more preferably in the range of 5000 psi to 7000 psi, and most preferably around 5000 psi (about 34.5 MPa), for an amount of packing time, preferably around 10 min. Prior to chromatographic evaluation and application, the montmorillonite packed column was washed with methanol and acetonitrile at a flow rate of 0.1 mL/min until a stable and constant column back-pressure was observed.

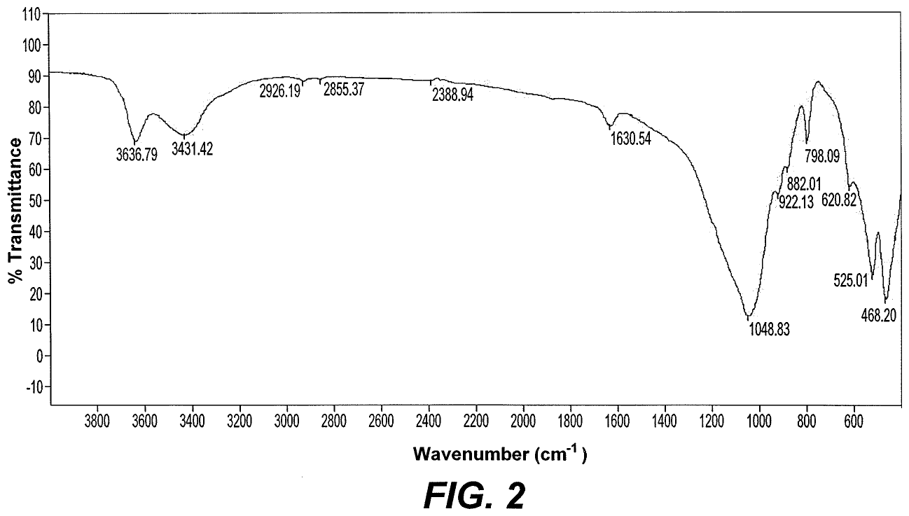

In order to identify the primary organic functional groups of the stationary phase material, a sample of the montmorillonite microparticles used to pack the column was examined by Fourier-transform infrared (FT-IR) spectroscopy. The FT-IR spectrum of the montmorillonite microparticles prepared as described above is shown in FIG. 2. Frequency peaks appear at 468 cm⁻¹, corresponding to Si—O—Si bending vibrations; 525 cm⁻¹, corresponding to the Si—O—Al (octahedral Al) group; 798 cm⁻¹, corresponding to Si—O stretching of quartz and silica; 922 cm⁻¹, corresponding to OH deformation frequency of Al—Al—OH structural moiety; 1048 cm⁻¹, corresponding to Si—O stretching; 1630 cm⁻¹, corresponding to interlayer H₂O deformation vibration; and finally 3431 and 3636 cm⁻¹, corresponding to OH stretching vibration of structural hydroxyl groups.

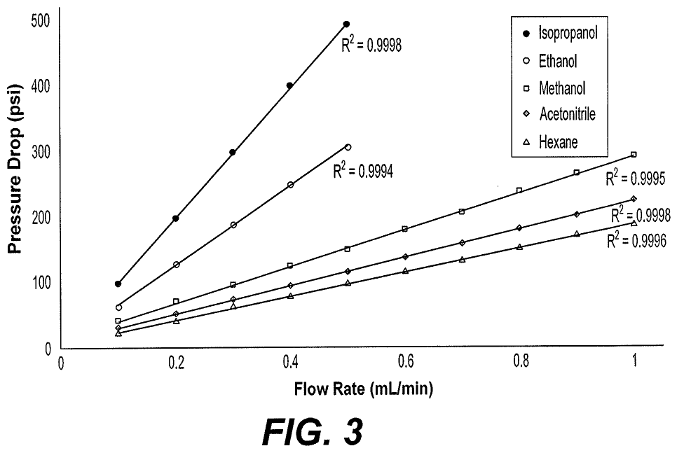

The stability of the montmorillonite microparticle column prepared as described above was also investigated. Different common chromatographic solvents were selected and passed through the columns in order to measure the column back-pressure at different flow rates. In particular, back-pressure flow rates ranging from 0.1 to 1.0 mL/min were tested for hexane, acetonitrile and methanol, and from 0.1 to 0.5 mL/min for ethanol and isopropanol. FIG. 3 shows the relationships between the mobile phase flow rate and column back-pressure. The prepared columns exhibited a back-pressure in ranges of 23 psi to 186 psi for hexane, 30 psi to 223 psi for acetonitrile, 41 psi to 291 psi for methanol, 62 psi to 304 psi for ethanol and 97 psi to 491 psi for isopropanol, given the tested flow rate range. In all cases, the column back-pressure did not exceed 500 psi, which is crucial to maintaining stability of montmorillonite inside the column, and to extend the lifetime of the separation column. As expected, the columns exhibited higher or lower pressure values according to solvent viscosity.

The pressure drop of the exemplary prepared columns increased linearly over the applied flow rate ranges; 0.1-1.0 mL/min for hexane, acetonitrile and methanol, and 0.1-0.5 mL/min for ethanol and isopropanol, at a constant column temperature of 25° C. A linear fit of the column back-pressure vs solvent flow rate has regression factors R² between 0.9994 and 0.9998, indicating good permeability and mechanical stability of the prepared montmorillonite columns.

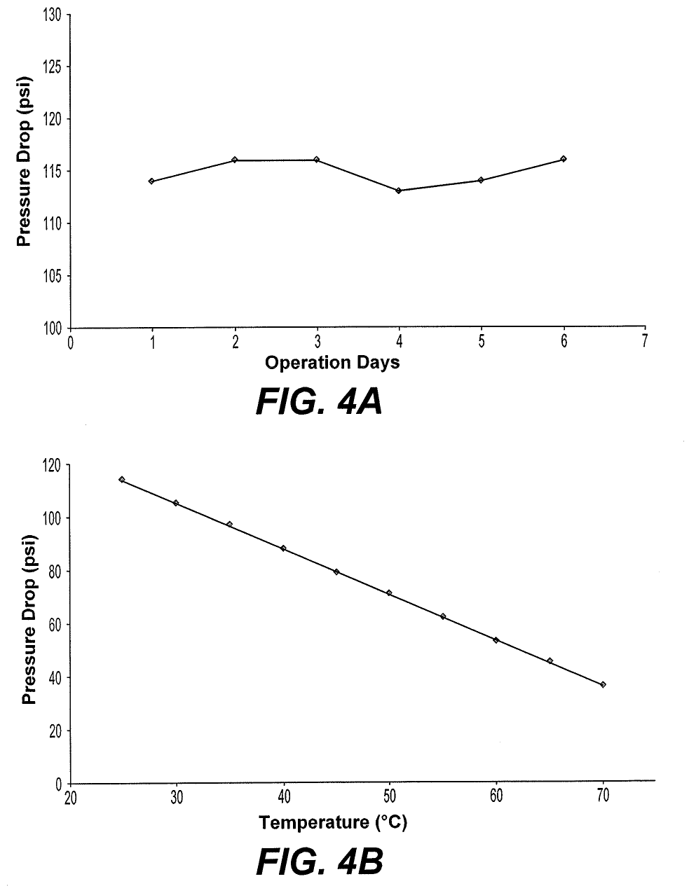

The stability of the exemplary columns prepared as above was evaluated over 6 successive days. FIG. 4A shows excellent stability in column back-pressure (about 114 psi±2 psi) was achieved over the operating days at a 0.5 mL/min flow rate, using pure acetonitrile as a mobile phase at 25° C. Further characterization of the montmorillonite microparticle stability in the column was carried out for varying column temperatures. FIG. 4B reveals that the pressure drop linearly decreased with column temperature within a range of 25° C. to 70° C., using acetonitrile as the mobile phase and a fixed flow rate of 0.5 mL/min. The back-pressure of the column dropped from 114 psi to 36 psi for the temperatures tested, corresponding to about a 9 psi decrease for each 5° C. increase. The pressure decrease is presumably directly related to the reduction of the mobile phase viscosity.

Exemplary HPLC columns were prepared as above with unmodified montmorillonite as the stationary phase and used in the following HPLC separation applications, although use of the montmorillonite-based liquid chromatography column is not limited to the particular polar compounds mentioned in the examples.

### Example 1

### Separation of Phenolic Compounds, Including Phenol, Resorcinol and Phloroglucinol

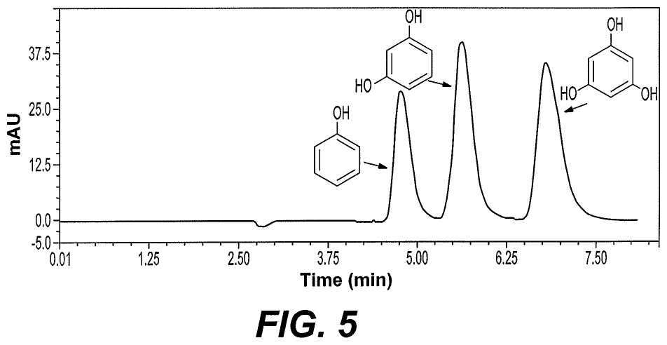

The montmorillonite-based liquid chromatography column was used to separate a mixture of phenolic compounds (i.e., phenol, resorcinol and phloroglucinol) under different conditions. Under optimized conditions, the three phenols were completely separated in less than 7.5 min, as shown in FIG. 5, using a binary hexane/ethanol (80:20, v/v) mobile phase mixture at a flow rate of 0.50 mL/min and a detection wavelength of 254 nm, with the column temperature fixed at 30° C.

The prepared column was evaluated in terms of plate numbers, capacity factors, peak asymmetry, and chromatographic resolution for each standard. The performance in terms of the column plate number was between 26,000 plates per meter for phenol and 28,900 plates per meter for resorcinol under optimum conditions. The capacity factors for phenol, resorcinol and phloroglucinol solutes were 0.73, 1.07 and 1.47, respectively, while the chromatographic resolution between the peaks was more than 1.84 in all cases. Peak asymmetry factors were 1.26, 1.29 and 1.44 for phenol, resorcinol and phloroglucinol, respectively.

### Example 2

### Separation of Caffeine and Ibuprofen Extracted from Profinal-XP Tablets

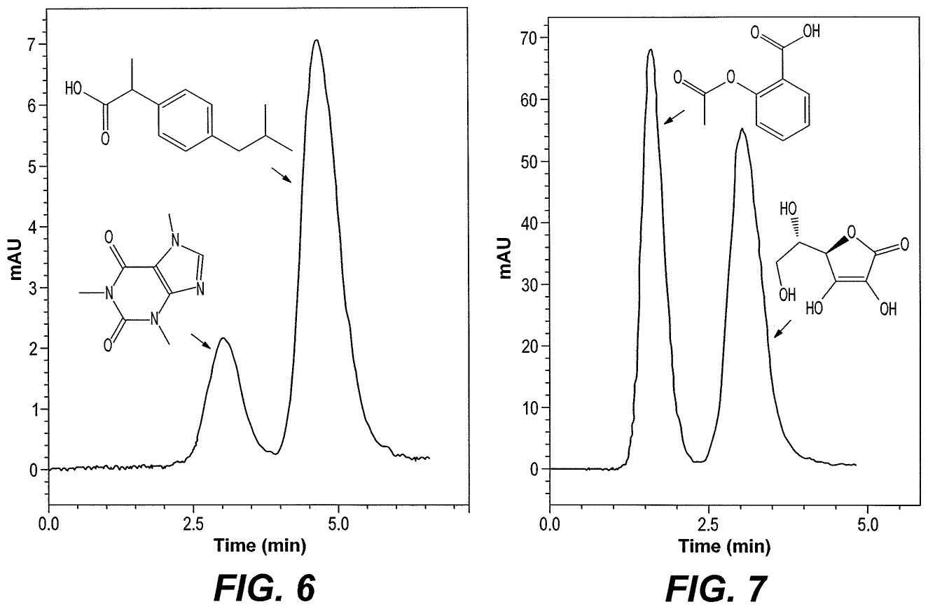

Exemplary montmorillonite-based liquid chromatography columns were applied for the separation of caffeine and ibuprofen drugs extracted from Profinal-XP tablets, labeled at 400 mg ibuprofen and 65 mg caffeine per tablet (manufactured by Julphar, Gulf Pharmaceutical Industries, Ras Al Khaimah, UAE), under different experimental conditions. As an example, FIG. 6 shows the separation of ibuprofen and caffeine in about 6 min with an acceptable resolution of 1.56, using a binary hexane/isopropanol (90:10, v/v) mobile phase composition, at a flow rate of 0.2 mL/min and a detection wavelength of 215 nm.

At optimum separation conditions, the column exhibited an efficiency of 4,200 plates per meter for caffeine and 5,300 plates per meter for ibuprofen, while a higher plate number was obtained at lower applied flow rates. The average tailing factor for caffeine and ibuprofen was 1.52 and 1.60, respectively. All parameters obtained after validation are in agreement with the criteria as per International Council for Harmonisation (ICH) guidelines.

### Example 3

### Separation of Vitamin C and Aspirin Extracted from Aspirin-C Tablets

Exemplary montmorillonite-based liquid chromatography columns were applied to separate vitamin C and aspirin compounds extracted from Aspirin-C tablets, labeled 400 mg aspirin and 240 mg vitamin C per tablet (produced by Bayer pharmaceutical company, Aktiengesellschaft AG, Germany), under different chromatographic conditions. At optimum chromatographic conditions, the two active ingredients were totally separated, as presented in FIG. 7, using a mobile phase mixture composed of hexane/isopropanol (85:15, v/v) at 0.25 mL/min flow rate. The compounds were detected at 230 nm UV wavelength, while the column was maintained at 30° C.

Under the above conditions, the two extracted compounds were separated in 4 min with a chromatographic resolution of 2.17. The calculated efficiency values of the column were 2,100 plates per meter for aspirin and 3,600 plates per meter for vitamin C. However, much higher plate number values were obtained at smaller flow rates. The average asymmetry factors were 1.23 for aspirin and 1.37 for vitamin C. All separation and efficiency parameters are in agreement with the criteria as per ICH documents.

### Example 4

### Separation of Paracetamol and Chlorzoxazone Extracted from Relaxon Capsules

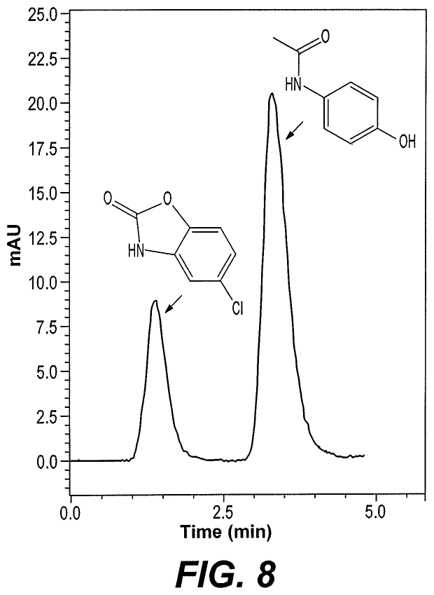

The prepared montmorillonite-based liquid chromatography columns were used to separate paracetamol and chlorzoxazone active ingredients extracted from Relaxon capsules, labeled 300 mg paracetamol and 250 mg chlorzoxazone per capsule (manufactured by Jamjoom Pharma, Jeddah, KSA), under different experimental conditions. As shown in FIG. 8, the compounds were completely separated, under the optimum conditions, in 4.3 min, with chromatographic resolution of 3.26 at a flow rate of 0.35 mL/min using a mobile phase composed of hexane/isopropanol (90:10, v/v). The UV detector was set at 270 nm, while the column temperature was applied at 30° C.

The column exhibited a good efficiency in terms of the number of theoretical plates with 4,400 plates per meter for chlorzoxazone and 7,100 plates per meter for paracetamol. The tailing factor for the detected peaks was 1.36 for chlorzoxazone and 1.41 for paracetamol. The analytical performance and validation parameters are in agreement with the criteria as per ICH guidelines.

The exemplary montmorillonite-based liquid chromatography columns, prepared and applied as in the above examples, proved to be stable, reproducible and efficient for separation of drug compounds under normal-phase liquid chromatography conditions. However, the montmorillonite-based liquid chromatography columns prepared as described above should be understood to be applicable to a wide range of other research and industrial areas. This could be achieved by specific functionalization of the surface of the montmorillonite microparticles (e.g., silylation, alkylation, acylation) to allow their use as stationary phase in either normal or reversed liquid chromatography modes. The montmorillonite microparticles prepared according to the present specification, and the HPLC columns prepared with the montmorillonite microparticles, provide a novel separation media that may open up promising avenues for food, environmental and pharmaceutical analysis.

It is to be understood that the montmorillonite-based liquid chromatography column is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A montmorillonite-based liquid chromatography column, comprising a high-performance liquid chromatography (HPLC) column packed with a stationary phase of montmorillonite, the montmorillonite being preheated before packing to remove water from silicon layers, wherein the montmorillonite stationary phase column has:
i) a uniform particle distribution size between 5 μm and 10 μm;
ii) a BET surface area of 339 m²/g;
iii) packing performed at a pressure of 5,000 psi; and
iv) a back-pressure less than 500 psi at 25° C.-70° C. at flow rates ranging from 0.1 to 1.0 mL/min.

2-5. (canceled)

6. The montmorillonite-based liquid chromatography column according to claim 1, wherein the HPLC column packed with the montmorillonite comprises a stainless steel column.

7. A method of making a montmorillonite-based liquid chromatography column, comprising the steps of:
sieving raw montmorillonite to obtain a uniform distribution of micron-sized montmorillonite particles;
drying the sieved montmorillonite;
suspending the dried montmorillonite in a solvent to form a suspension; and
packing a high-performance liquid chromatography column with the suspension of sieved montmorillonite to form a montmorillonite stationary phase in the column.

8. The method of making a montmorillonite-based liquid chromatography column according to claim 7, wherein the micron-sized montmorillonite particles have an average particle size between 5 μm and 10 μm.

9. The method of making a montmorillonite-based liquid chromatography column according to claim 7, wherein said step of drying the sieved montmorillonite comprises heating the sieved montmorillonite in an oven at 100° C. for two hours.

10. The method of making a montmorillonite-based liquid chromatography column according to claim 7, wherein the solvent is ethanol, the sieved montmorillonite being sonicated in the ethanol solvent for 10 minutes to form the suspension.

11. The method of making a montmorillonite-based liquid chromatography column according to claim 7, wherein the packing is performed at a pressure of 5,000 psi for 10 minutes.

12. The method of making a montmorillonite-based liquid chromatography column according to claim 7, wherein the high-performance liquid chromatography column comprises a stainless steel column.
